(19) United States
(12) Patent Application Publication
(10) Pub. No.: US 2008/0311898 A1
(43) Pub. Date: Dec. 18, 2008

(54) Network support for swimming pool monitoring and control

(76) Inventors: David S. Benco, Winfield, IL (US); Sanjeev Mahajan, Naperville, IL (US); Baoling S. Sheen, Naperville, IL (US); Sandra L. True, St. Charles, IL (US)

Correspondence Address: PATTI , HEWITT & AREZINA LLC, ONE NORTH LASALLE STREET, 44TH FLOOR, CHICAGO, IL, 60602, US

(21) Appl. No.: 11/811,975

(22) Filed: Jun. 13, 2007

(51) Int. Cl. H04M 3/00

(52) U.S. Cl. 455/419

(57) ABSTRACT

An apparatus in one example has: a controllable system having a plurality of controllable parameters; a plurality of sensors for respectively detecting the plurality of controllable parameters, the sensors providing respective sensor data indicative of the plurality of controllable parameter; a control center that is operatively coupled to the controllable system, the control center receiving the sensor data; a communication module in the control center, the communication module having a transceiver that communicates with a mobile terminal in a wireless telecommunication network wherein the communication module sends the sensor data and receives respective control data in response thereto; wherein the control center applies the control data to the controllable system to respectively change the controllable parameters. In one embodiment the controllable system is a swimming pool.

### TECHNICAL FIELD

The invention relates generally to telecommunication networks, and more particularly to a telecommunication network that provides monitoring and control of a predetermined area, such as a swimming pool.

### BACKGROUND

Today swimming pools are very common, both public facilities and home models. Although public facilities are closely monitored, swimming pools installed, for example, in the backyards of homes are not as closely monitored. Home pools typically have pumps and filters that are controlled by a timer unit that turns the pumps and filters on and off at least once a day.

Many homes are unoccupied during the day when individuals are at work, and the pools may develop problems due to power failures or breakdown of equipment. The owners of the swimming pool may not find out about the problem until they arrive home after work.

This problem is more severe when, for example, a family is gone for a weekend, or a vacation that may be for two weeks or more. If the pump and/or filter were to fail, the pool may be damaged or at least involve a substantial cleanup that may be costly.

Thus, there is a need in the art for an improved apparatus and method for monitoring and controlling the operation of a swimming pool, especially from a remote location.

### SUMMARY

One implementation encompasses an apparatus. This embodiment of the apparatus may comprise: a controllable system having a plurality of controllable parameters; a plurality of sensors for respectively detecting the plurality of controllable parameters, the sensors providing respective sensor data indicative of the plurality of controllable parameter; a control center that is operatively coupled to the controllable system, the control center receiving the sensor data; a communication module in the control center, the communication module having a transceiver that communicates with a mobile terminal in a wireless telecommunication network wherein the communication module sends the sensor data and receives respective control data in response thereto; wherein the control center applies the control data to the controllable system to respectively change the controllable parameters. In one embodiment the controllable system is a swimming pool.

One implementation encompasses a method. This embodiment of the method may comprise: mobile subscriber initiates control command to network; network checks if subscriber has purchased feature and is authorized; if the subscriber is not an authorized subscriber, respond with error message; if the subscriber is an authorized subscriber, network forwards command to defined swimming pool control center; swimming control center executes the command and sends acknowledgement to the network; and network forwards acknowledgement to subscriber.

Another implementation encompasses a method. This embodiment of the method may comprise: network queries swimming pool control center for information on periodic basis; network checks if information collected exceeds defined thresholds; if threshold has not been exceeded, do nothing; if threshold has been exceeded, network queries subscriber database for alarming notification preference; and network notifies mobile subscriber of pool alarm notification according to their notification preference.

### DESCRIPTION OF THE DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 is a representation of one implementation of an apparatus that provides for monitoring and controlling the operation of a swimming pool, especially from a remote location;

FIG. 2 depicts one embodiment of a control center 200 that may be operatively coupled to the swimming pool;

FIG. 3 is a representation of one exemplary flow diagram for a monitor and generate alarm scenario for a swimming pool monitoring and control system; and

FIG. 4 is a representation of one exemplary flow diagram for a control command scenario for a swimming pool monitoring and control system.

### DETAILED DESCRIPTION

In this day and age when many mobile subscribers lead an active lifestyle where they are always on the go, it would be useful to be able to use their mobile handset for the purpose of making routine activities more automatic. Therefore, according to one embodiment of the present method and apparatus a cellular telecommunications network may be used as a vehicle for enabling the monitoring of home swimming pool information and the subsequent alarming or notification to the subscriber when some pre-defined user thresholds have been reached. For example, the level and temperature of the pool water may be monitored. The chemical levels in the pool may be monitored. The clarity of the water may be monitored. Then depending on the alarmable condition that arose, the mobile subscriber may be notified via his/her cell phone (also referred to in general as a mobile terminal) of the condition, and they may respond by remotely controlling the heater, the filter, the chemical dispenser, the water inlet supply, etc. through the use of their mobile terminal.

It is to be understood that although the present method and apparatus is described in the context of a swimming pool, numerous other items, systems and structures may be monitored and controlled from a remote location according to the present method and apparatus. Thus, a swimming pool is representative of any type of system to be monitored and controlled, such as a heating and cooling system for a house or business, a hydroponics business, etc.

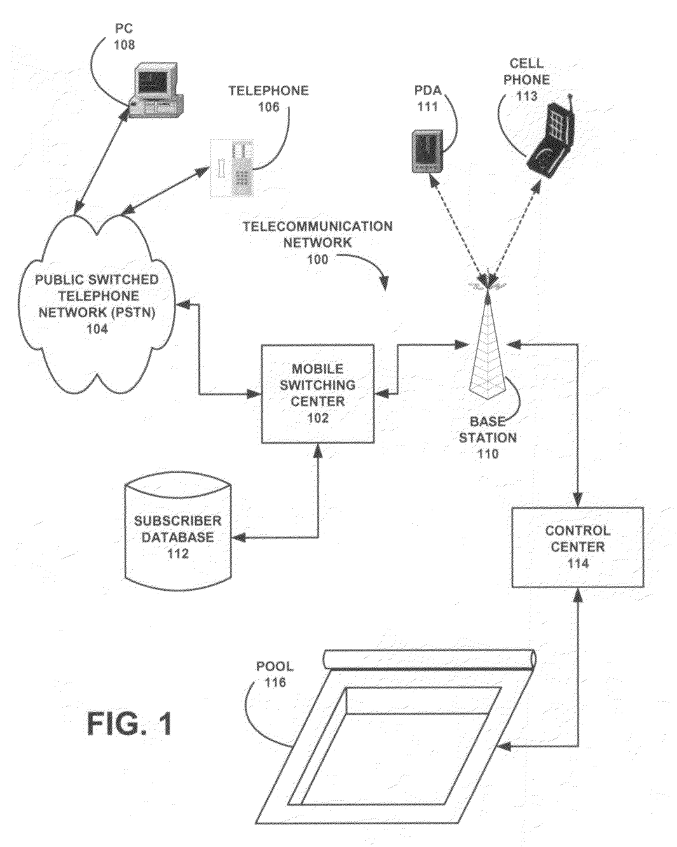

FIG. 1 is a representation of one implementation of an apparatus that provides for monitoring and controlling the operation of a swimming pool, especially from a remote location.

A telecommunications network 100 may have a mobile switching center (MSC) 102. The network 100 may be, or may be part of, one or more of a telephone network, a local area network (“LAN”), the Internet, and a wireless network. In the depicted embodiment, a public switched telephone network (PSTN) 104 may be operatively coupled to the MSC 102. The PSTN 104 routes calls to and from a telephone 106 and/or a personal computer (PC) 108. The MSC 102 may also be operatively coupled to at least one base station (BS) 110. The base station 110 may communicate with a mobile terminal, such as personal data assistant (PDA) 111 and/or cell phone 113, for example, in its service area using a subscriber database 112.

Although the present system and method may be used with any type of network (wired and wireless, for example), the subscriber may typically be a mobile subscriber who uses a mobile terminal 113 (also referred to as mobile phone, a cell phone, mobile handset, or car phone). The mobile terminal 113 may have a home location register (HLR) in the subscriber database 112 where data about the mobile terminal resides. The subscriber database 112 may be operatively coupled to the mobile switching center 102, and may be either part of the mobile switching center 102 or external from the mobile switching center 102.

Embodiments of the present method and apparatus may have a control center 114 that is operatively coupled to a home swimming pool 116, for example. A transceiver device in the control center 114 may be connected and integrated with the home swimming pool mechanical control system (e.g. filter, heater, chemical dispenser, water supply) as will be described below.

Thus, a methodology according to the present method and apparatus is for the telecommunications network to communicate with a swimming pool mechanical system that has been integrated with transceiver functions.

A further methodology according to the present method and apparatus is for the telecommunications network to periodically retrieve swimming pool operational status information and raise an alarm when the information received exceeds any defined thresholds (e.g., water temperature too cold, chlorine level below threshold, etc.).

Another methodology according to the present method and apparatus is for the telecommunications network to receive swimming pool information when a mechanical fault has been detected (e.g., circulation pump breakdown).

Yet another methodology according to the present method and apparatus is for the telecommunications network to notify a mobile subscriber via an SMS message, an email message, or a phone call, that an alarm has been received or a fault detected.

A further methodology according to the present method and apparatus is for a mobile subscriber to issue control commands from a mobile terminal to control operation of a heater, filter, chemical dispenser, or water supply (e.g. turn heater or filter on or off, turn temperature of heater up or down, turn chemical dispenser on or off or up or down, turn water supply on or off.)

Another methodology according to the present method and apparatus is for the telecommunications network to acknowledge the execution of the control commands forwarded to the swimming pool operations control center.

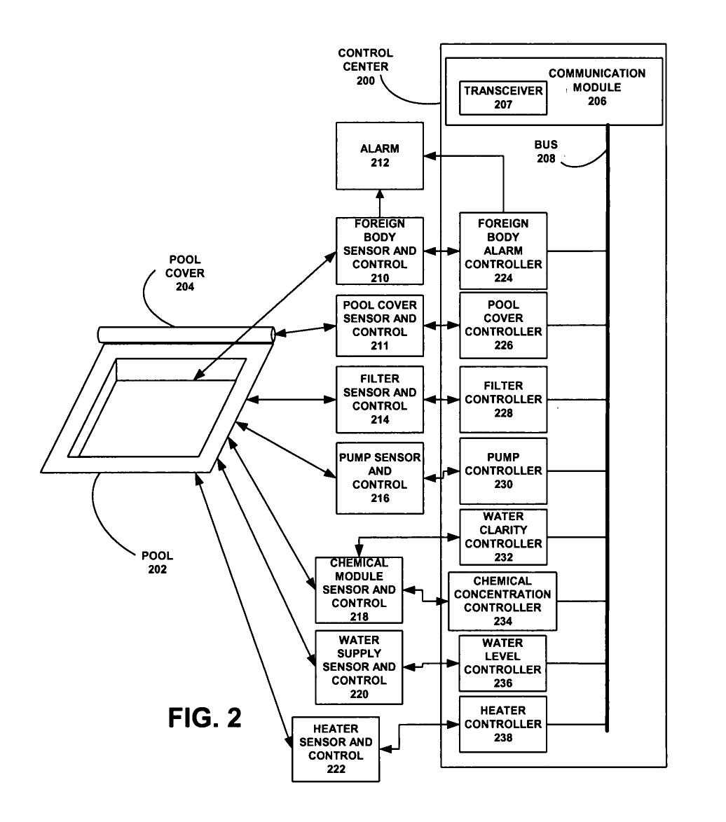

FIG. 2 depicts one embodiment of the control center 200 that may be operatively coupled to a swimming pool 202 the may optionally have a motorized pool cover 204. The control center 200 may have a communication module 206 that is operatively coupled to a bus 208. The communication module 206 may have a transceiver 207 that communicates with a wireless communication system, such as the wireless communication system depicted in FIG. 1.

The swimming pool 202 may have a large variety of configurations and equipment associated therewith. For example, a foreign body sensor 210 may be provided. The foreign body sensor 210 detects, for example, when a child falls into an unattended pool. The foreign body sensor 210 may be operatively coupled to an alarm 212 that sounds. In addition when the foreign body sensor 210 is activated, a call may be automatically placed to a 911 operator. A filter 214 and a pump 216 may be operatively coupled to the swimming pool 202 for circulating and filtering water in the swimming pool 202. The swimming pool 202 may also have a chemical module 218 by which the chemicals may be added to the water in the swimming pool 202, a water supply module 220 that may be used to add water to the swimming pool 202, and a heater 222 that may be used to heat the water in the swimming pool 202. A pool cover sensor 211 may be operatively coupled to the pool cover 204.

The control center 200 may have a plurality of controllers that are operatively coupled to the equipment associated with the swimming pool 202. This equipment may also be operatively coupled to the communication module 206 via the bus 208. For example, the control center 200 may have a foreign body alarm controller 224, pool cover controller 226, filter controller 228, pump controller 230, water clarity controller 232, chemical concentration controller 234, water level controller 236, and heater controller 238. It is to be understood that these functions may be implemented in a variety of ways and combinations by a variety of equipment, such as individual modules, a programmable controller, etc. In general, each of the controllers detects respective parameters relative to the swimming pool 202 and forwards sensor data indicative thereof to the communication module 206. The communication module 206 then sends the sensor data to the wireless communication system via the transceiver 207.

Embodiments of the present method may have, in general, the following steps:

Mobile subscriber subscribes to this new swimming pool monitor/control feature.

Periodically, the telecommunications network queries the swimming pool control center for information to be monitored (e.g. water level, chemical level, water temperature, clarity level, etc.), or the swimming pool control center may report periodically, without being queried, or the swimming pool control center may report only when alarmable conditions occur or mechanical faults occur.

The telecommunications network may notify the mobile subscriber of condition detected and reported. This notification may be in whatever form the mobile subscriber has chosen as his preferential notification type, for example, SMS message, phone call, email message, etc.

The mobile subscriber may respond to the notification by issuing a control command from their mobile terminal to turn one of the mechanical systems on or off, or up or down depending on the type of alarm that was received.

The telecommunications network may receive that command and forward it to the corresponding swimming pool control center where the appropriate action may be taken.

The swimming pool control center may issue an acknowledgement back to the network that the action was taken, and the network may forward that acknowledgement onto the mobile subscriber to confirm that his request was executed.

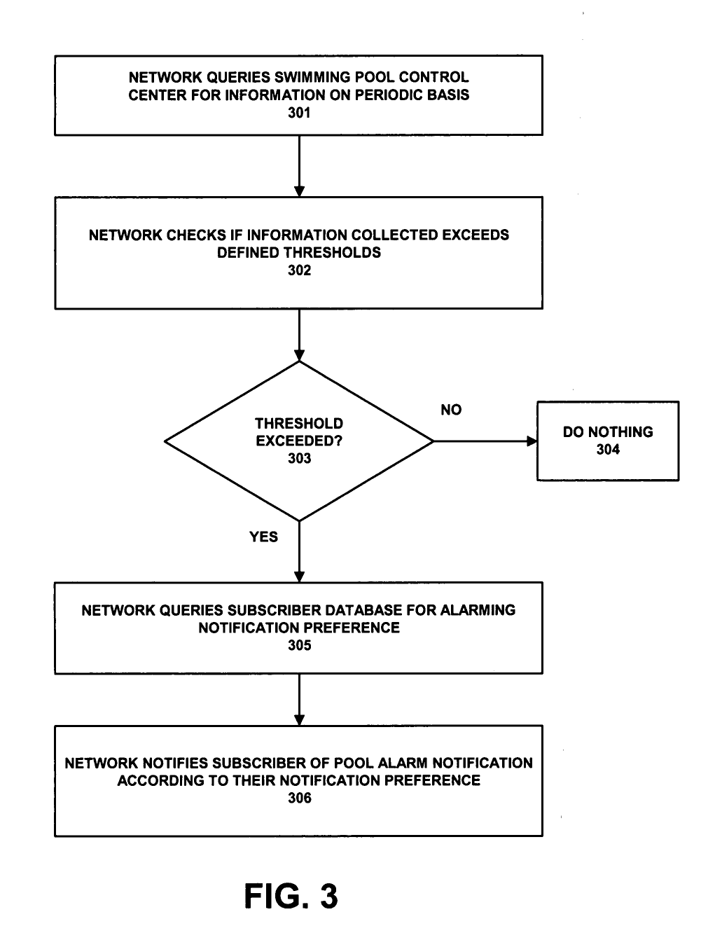

FIG. 3 is a representation of one exemplary flow diagram for a monitor and generate alarm scenario for a swimming pool monitoring and control system. The method may have the steps of: network queries swimming pool control center for information on periodic basis (301); network checks if information collected exceeds defined thresholds (302); if threshold (303) has not been exceeded, do nothing (304); if threshold (303) has been exceeded, network queries subscriber database for alarming notification preference (305); and network notifies mobile subscriber of pool alarm notification according to their notification preference (306).

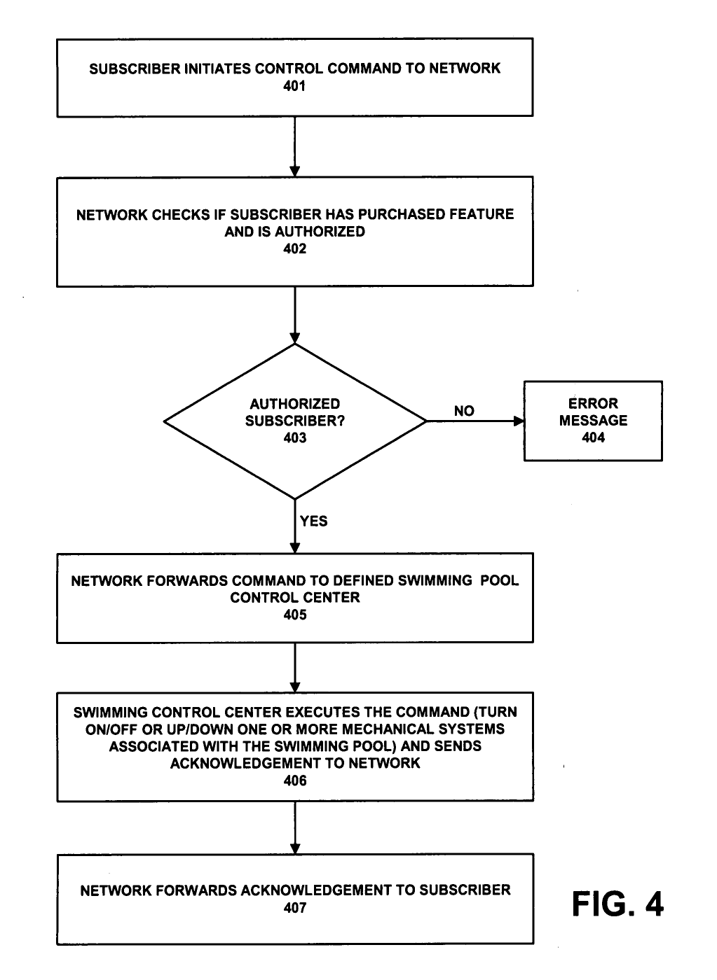

FIG. 4 is a representation of one exemplary flow diagram for a control command scenario for a swimming pool monitoring and control system. The method may have the steps of: mobile subscriber initiates control command to network (401); network checks if subscriber has purchased feature and is authorized (402); if the subscriber is not an authorized subscriber (403), respond with error message (404);. if the subscriber is an authorized subscriber (403), network forwards command to defined swimming pool control center (405); swimming control center executes the command (turn on/off or up/down one or more mechanical systems associated with the swimming pool) and sends acknowledgement to the network (406); and network forwards acknowledgement to subscriber (407).

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. Examples of a computer-readable signal-bearing medium for the apparatus may comprise the recordable data storage medium (subscriber database). The computer-readable signal-bearing medium for the apparatus in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a controllable system having at least one controllable parameter;
at least one sensor for detecting the at least one controllable parameter, the sensor providing sensor data indicative of the at least one controllable parameter;
a control center that is operatively coupled to the controllable system, the control center receiving the sensor data;
a communication module in the control center, wherein the communication module sends the sensor data and receives control data in response thereto;
wherein the control center applies the control data to the controllable system to change the controllable parameter.

2. The apparatus according to claim 1, wherein the communication module has a transceiver that communicates with a wireless telecommunication network.

3. The apparatus according to claim 1, wherein the communication module has a transceiver that communicates with a mobile terminal in a wireless telecommunication network.

4. The apparatus according to claim 1, wherein the controllable system has a plurality of controllable parameters, and a plurality of sensors for detecting the plurality of controllable parameters.

5. The apparatus according to claim 1, wherein the controllable system is a swimming pool.

6. The apparatus according to claim 5, wherein the swimming pool is operatively coupled to at least one of a foreign body sensor, a filter, a pump, a chemical module, a water supply module, and a heater.

7. The apparatus according to claim 6, wherein the control center has a foreign body alarm controller operatively coupled to the foreign body sensor, a filter controller operatively coupled to the filter for controlling and sensing operation of the filter, a pump controller operatively coupled to the pump for controlling and sensing operation of the pump, a water clarity controller operatively coupled to the chemical module for controlling and sensing water clarity, a chemical concentration controller operatively coupled to the chemical module for controlling and sensing chemical concentration of chemicals in the swimming pool, a water level controller operatively coupled to the water supply for controlling and sensing operation of the water supply, and a heater controller operatively coupled to the heater for controlling and sensing operation of the heater.

8. The apparatus according to claim 7, wherein the swimming pool has a motorized pool cover, and wherein the motorized pool cover is operationally coupled to a pool cover sensor, and wherein the control center has a pool cover controller operatively coupled to pool cover sensor and to the motorized pool cover.

9. The apparatus according to claim 1, wherein the communication module has a transceiver that communicates with a wireless telecommunication network, and wherein the apparatus further comprises at least one threshold, and wherein the sensor data, corresponding to the at least one controllable parameter, is compared to the at least one threshold, and wherein in response to the comparison control data is sent from the wireless telecommunication network to the controllable system to thereby change the at least one controllable parameter.

10. The apparatus according to claim 9, wherein the at least one threshold is stored in the wireless telecommunication network.

11. The apparatus according to claim 3, wherein the wireless communications network periodically retrieves respective sensor data from the control center.

12. An apparatus, comprising:
a controllable system having a plurality of controllable parameters;
a plurality of sensors for respectively detecting the plurality of controllable parameters, the sensors providing respective sensor data indicative of the plurality of controllable parameter;
a control center that is operatively coupled to the controllable system, the control center receiving the sensor data;
a communication module in the control center, the communication module having a transceiver that communicates with a mobile terminal in a wireless telecommunication network wherein the communication module sends the sensor data and receives respective control data in response thereto;
wherein the control center applies the control data to the controllable system to respectively change the controllable parameters.

13. The apparatus according to claim 12, wherein the controllable system is a swimming pool.

14. The apparatus according to claim 13, wherein the swimming pool is operatively coupled to at least one of a foreign body sensor, a filter, a pump, a chemical module, a water supply module, and a heater, and wherein the control center has a foreign body alarm controller operatively coupled to the foreign body sensor, a filter controller operatively coupled to the filter for controlling and sensing operation of the filter, a pump controller operatively coupled to the pump for controlling and sensing operation of the pump, a water clarity controller operatively coupled to the chemical module for controlling and sensing water clarity, a chemical concentration controller operatively coupled to the chemical module for controlling and sensing chemical concentration of chemicals in the swimming pool, a water level controller operatively coupled to the water supply for controlling and sensing operation of the water supply, and a heater controller operatively coupled to the heater for controlling and sensing operation of the heater.

15. The apparatus according to claim 14, wherein the swimming pool has a motorized pool cover, and wherein the motorized pool cover is operationally coupled to a pool cover sensor, and wherein the control center has a pool cover controller operatively coupled to pool cover sensor and to the motorized pool cover.

16. The apparatus according to claim 12, wherein the apparatus further comprises a plurality of thresholds that are stored in the wireless telecommunication network, and wherein the sensor data, corresponding to the plurality of controllable parameters, is compared to the plurality of thresholds, and wherein in response to the comparison, respective control data is sent from the wireless telecommunication network to the controllable system to thereby respectively change the plurality of controllable parameters.

17. The apparatus according to claim 12, wherein the wireless communications network periodically retrieves respective sensor data from the control center.

18. A method, comprising:
detecting at least one controllable parameter of a swimming pool, and providing sensor data indicative of the at least one controllable parameter to a swimming pool control center;
sending the sensor data to a mobile terminal via a wireless telecommunication network and receiving control data in response thereto; and
applying the control data to thereby change the at least one controllable parameter.

19. The apparatus according to claim 18, wherein the method further comprises: network queries swimming pool control center for information on periodic basis; network checks if information collected exceeds defined thresholds; if threshold has not been exceeded, doing nothing; if threshold has been exceeded, network querying a subscriber database for alarming notification preference; and network notifying a mobile terminal of pool alarm notification according to the notification preference.

20. The apparatus according to claim 18, wherein the method further comprises: mobile terminal initiating control command to network; network checking if mobile terminal is authorized; if the mobile terminal is not authorized, responding with an error message; if the mobile terminal is authorized, network forwarding control data to swimming pool control center; swimming control center applying the control data and sending acknowledgement to the network; and network forwarding acknowledgement to mobile terminal.
